(19) United States
(12) Patent Application Publication
(10) Pub. No.: US 2006/0048648 A1
(43) Pub. Date: Mar. 9, 2006

(54) Parallel passage contactor structure

(75) Inventors: Andrea C. Gibbs, Burnaby (CA); Aaron M. Pelman, Vancouver (CA)

Correspondence Address: KLARQUIST SPARKMAN, LLP, 121 SW SALMON STREET, SUITE 1600, PORTLAND, OR, 97204, US

(73) Assignee: QuestAir Technologies Inc.

(21) Appl. No.: 11/207,496

(22) Filed: Aug. 19, 2005

Related U.S. Application Data
(60) Provisional application No. 60/603,450, filed on Aug. 20, 2004.

(51) Int. Cl. B01D 53/02

(52) U.S. Cl. 96/108

(57) ABSTRACT

An inventive improved parallel passage contactor structure demonstrating enhanced fluid flow performance is disclosed. Such improved parallel passage contactor structure may be adapted for many fluid/solid interaction processes such as catalytic gas reaction, fluid treatment, or adsorptive gas separation including pressure, temperature and partial pressure swing adsorption. Improved contactor structures according to the invention have Gas Flow Parameter values less than about 1.8E-4 Pa*s/m, which provide for enhanced process performance in applications such as adsorptive gas separation (holding other system variables constant). Some embodiments of the improved contactor structures incorporate improved mesh spacer materials having Open Volume Ratio values greater than about 85%.

### PRIORITY CLAIM

This application claims the benefit of U.S. Provisional Application No. 60/603,450, filed Aug. 20, 2004.

### FIELD

The present disclosure relates to parallel passage contactors and more particularly to parallel passage contactors having an improved structure and design.

### BACKGROUND

Parallel passage contactors are useful in many industrial processes and applications requiring efficient contact of a fluid with a solid material or surface. In particular, parallel passage contactors may be applied to the field of gas separation, and more particularly adsorptive gas separation, including pressure swing and temperature swing adsorption gas separation processes, which require the efficient contact of a gas mixture with a solid adsorbent material. The structure of parallel passage contactors, including fixed surfaces on which adsorbent or other active material may be held, provides benefits over previous conventional gas contacting methods, such as vessels containing adsorbent beads or extruded adsorbent particles.

Parallel passage contactor structures have been disclosed in the prior art such as in the Applicant's co-pending U.S. patent application Ser. No. 10/041,536, filed Jan. 7, 2002 (and published as US-2002-0170436-A1 on Nov. 21, 2002) entitled “Adsorbent Coating Compositions, Laminates and Adsorber Elements Comprising Such Compositions and Methods for their Manufacture and Use”, the contents of which are herein incorporated by reference in their entirety. Such prior art disclosures include descriptions of parallel passage contactor embodiments adapted for specific gas exchange processes such as pressure swing adsorption processes (including vacuum swing adsorption), and incorporating layered sheet elements arranged to form a parallel passage contactor structure suitable for flowing gas therethrough and where the gas flowing therethrough is in contact with the surfaces of the sheet elements.

### SUMMARY

Disclosed herein is an improved structure for a parallel passage contactor comprising at least one active material sheet layer and at least one spacer material sheet layer, positioned adjacent to the active material sheet layer. The spacer material sheet layer provides a fluid flow channel adjacent to and in contact with the active material sheet layer to allow the passage of a fluid, such as a gas, in contact with the active material. Parallel passage contactor structure embodiments incorporating improved spacer layer materials as disclosed herein, allow for improved fluid flow performance while also allowing for improved manufacturability of the contactor structure, and reduced cost of the structure relative to structures according to the prior art.

Parallel passage contactor structures provide lower fluid flow pressure drop values per unit length of the contactor structure for the same spacer layer thickness, relative to existing structures, thereby improving fluid flow performance of the contactor relative to existing structures. Improved fluid flow performance is a key indicator of the relative performance of a contactor structure for many types of applications including fluid reaction structures, adsorptive gas separation structures and catalytic gas reaction support structures, when other system variables remain constant. In the case of adsorptive gas separation by pressure, temperature, or partial-pressure swing adsorption, improved gas flow performance has been found to result in increased adsorptive separation performance for a contactor structure, all other variables remaining constant. The inventive contactor structures additionally allow for improved manufacturability and structural homogeneity and precision of the improved contactors according to known manufacturing techniques including but not limited to flat parallel layered structures, and spirally wound layered structures, relative to structures according to the prior art.

The fluid flow performance of parallel passage contactor structures, including the presently disclosed improved structures, such as for use in gas-phase applications including adsorptive gas separation, may be measured by testing according to a pressure drop test procedure using air as a test fluid, such as is employed in the art. According to the results of such pressure drop testing, the relative gas flow performance (as a representative fluid) of the structure may be characterized by the value of a spacer material-specific parallel passage Gas Flow Parameter (GFP). The spacer-specific parallel passage Gas Flow Parameter (GFP) of a contactor structure is defined according to the following equation where units of measurement are shown in {brackets}:

$$GFP \{ Pa * s / m \} = \frac{\begin{matrix}[ Pressure drop of contactor structure ] * \\ {[ spacer layer thickness ]}^{3}\end{matrix}}{\begin{matrix}[ length ] * [ x \text{-} sectional area of contactor structure ] * \\ [ gas entrance velocity ]\end{matrix}}$$

It may be noted that the gas entrance velocity above is as measured at the entrance to the parallel passage contactor structure. Under such testing, the contactor structure specifications may be held constant (such as the thickness of active material layers, method of layering of active material and spacer layers, etc.) and only the characteristics of the spacer material varied in order to maximize the gas flow performance for the exemplary contactor structure specification. According to the results of such Gas Flow Parameter testing, lower values of the GFP represent increased gas flow performance of the contactor structure, keeping all other variables constant.

In one embodiment, improved parallel passage contactor structures may be characterized under pressure drop testing using air as a test fluid as having values of the above referenced spacer-specific parallel passage Gas Flow Parameter of less than about 1.8E-4 Pa*s/m.

In preferred embodiments of the fluid contactor structures, at least a portion of the active material sheet layer may comprise an active material, which may include but is not limited to catalyst materials, adsorbent materials, or other active materials effective to enable an adsorption, catalysis or other reaction process to be carried out involving a fluid, such as a gas or liquid, present in the fluid flow channels adjacent to the active material layers. In embodiments adapted for use in adsorptive gas separation processes, the active material layers may comprise adsorbent materials including but not limited to molecular sieves, zeolites, activated carbons, carbon molecular sieves, silica gels, aluminas, and combinations thereof.

In a second embodiment, the inventive contactor structure may incorporate preferred mesh-type sheet materials as an improved mesh spacer layer material to improve the gas flow performance of the structure, holding other structure variables constant. Such improved mesh spacer materials may be characterized as having an open volume ratio (OVR) of greater than 85%, where the open volume ratio (OVR) of the mesh spacer material is defined according to the following equation:

$$OVR = \frac{\begin{matrix}( total volume of mesh spacer layer ) - \\ ( volume of mesh material filaments )\end{matrix}}{( total volume of mesh spacer layer )} \times 100 \%$$

The improved mesh spacer materials may comprise any mesh-type material suited chemically and structurally for the construction and operation of the inventive parallel passage contactor, which may comprise meshes formed of plastic, metal, glass, carbon, and crystalline microporous materials or combinations thereof. In a particular such embodiment, the improved mesh spacer materials may have a thickness between about 75 and 400 microns.

### BRIEF DESCRIPTION OF THE DRAWINGS

FIG. 1 is a graph showing the relative gas flow performance of improved parallel passage contactor structures according to the present invention, compared to existing contactor structures known in the art as represented by GFP values derived from pressure drop testing using air as a test fluid.

FIG. 2 is a graph showing the relative adsorptive gas separation performance of parallel passage contactor structures according to the present invention, compared to existing contactor structures known in the art, as represented by product yield percentage derived from pressure swing adsorption testing under two representative test conditions.

FIG. 3 is a graph showing the relative adsorptive gas separation performance of parallel passage contactor structures according to the present invention, compared to existing contactor structures known in the art, as represented by a normalized relative productivity value corresponding to the productivity of adsorption (productivity defined as liters of product gas produced per liter of adsorbent material per hour) derived from pressure swing adsorption testing under two representative test conditions.

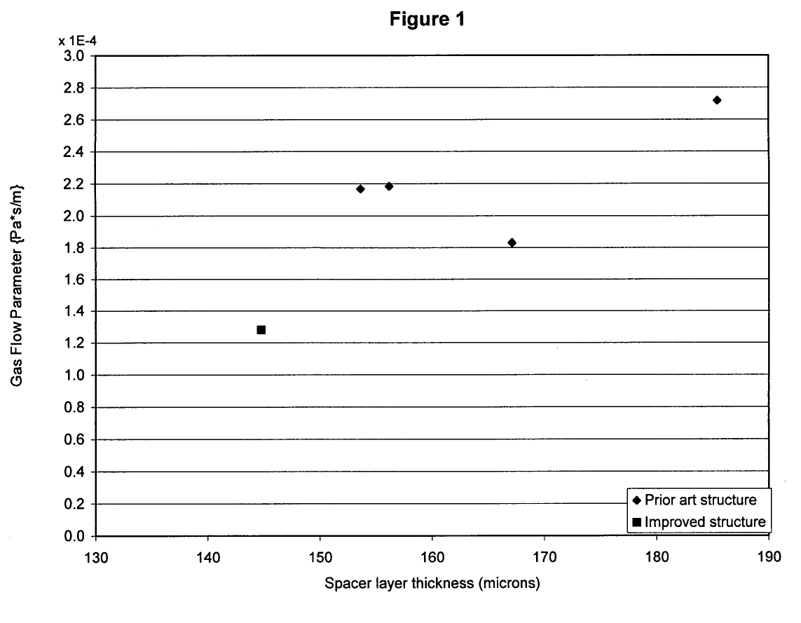

The improved parallel contactor structure employed in the tests, the results of which are depicted in FIGS. 1-3, includes a spacer material of stainless steel mesh having wire filament diameters of 76 microns, an interfilament spacing of 847 microns and an OVR of 91%.

### DETAILED DESCRIPTION OF SEVERAL EMBODIMENTS

As described in the summary above, the present disclosure describes improved parallel passage contactor structures for use in fluid contact applications, including gas processing applications such as adsorptive gas separation, catalytic gas reaction, and particularly rapid cycle adsorptive gas separation such as rapid cycle pressure swing adsorption (RCPSA). The parallel passage contactors disclosed herein have improved fluid (particularly gas) flow performance relative to the parallel passage contactor structures of the prior art. The improved gas flow performance of the present improved contactor structures also have been found to improve the relative performance of the improved contactor structures for use in fluid contact applications, including gas phase applications, such as catalytic gas reaction, adsorptive gas separation, and particularly, RCPSA, all other system variables being constant.

The improved parallel passage contactor structures disclosed herein comprise at least one active material sheet layer, and at least one spacer material sheet layer which is positioned next to the active material layer in order to establish a fluid flow channel whereby fluid can flow through the structure in contact with the active material sheet. In a particular application of the improved inventive contactor structures for use in adsorptive gas separation, and particularly RCPSA, the active material may comprise any suitable adsorbent material, and the active material sheet may comprise any suitable generally thin or sheet-like material comprising the adsorbent material such as those known in the art. Such suitable adsorbent sheets may comprise any suitable adsorbent material attached to a substrate material such as, but not limited to a metal foil, expanded metal foil, embossed metal foil, ceramic or composite mesh, metal mesh, glass fiber fabric, glass fiber scrim, carbon fiber fabric, cellulosic fabric or scrim, or polymeric mesh, fabric or scrim, or any combination thereof. Alternatively, suitable adsorbent sheets may be without separate substrate material, comprising, but not limited to activated carbon cloth or fabric or otherwise self-supported adsorbent sheets, such as the substrate-less zeolite sheets described in the Applicant's co-pending U.S. patent application Ser. No. 10/954,251 entitled “High Density Adsorbent Structures,” which is incorporated herein in its entirety. As known in the art, suitable adsorbent materials for RCPSA, which are also suitable for incorporation in the active material sheets in the inventive parallel passage contactor structure comprise molecular sieves, zeolites, activated carbons, carbon molecular sieves, silica gels, aluminas, and combinations thereof. In certain embodiments, the general methods for making the parallel passage contactor structures are disclosed in U.S. patent application Ser. No. 10/041,536, filed Jan. 7, 2002 (and published as US-2002-0170436-A1 on Nov. 21, 2002) which is incorporated herein by reference in its entirety.

As is known in the art, the performance of parallel passage fluid contactor structures may be tested by means of a pressure drop test, whereby a test fluid is passed through the contactor structure to determine the pressure drop in the fluid pressure over the length of the contactor. Contactor structures demonstrating less drop in fluid pressure are preferred as being of higher fluid flow performance, such that less fluid pressure may be required in order to result in a given fluid flow rate through the contactor structure. In the application of parallel passage contactors to gas phase applications, such as RCPSA in particular, pressure drop testing of parallel passage contactor structures such as the present improved inventive structures may be conducted using air as a test fluid in order to determine the fluid flow performance of the structure. Measurements of the value of the Gas Flow Parameter (GFP) as defined above can be made using the results of such pressure drop testing in order to compare the relative performance of contactor structures, with a lower value for the GFP indicative of better fluid flow performance.

In applications of parallel passage contactors related to adsorptive gas separation, and particularly RCPSA, the Applicants have determined that adsorptive performance of an adsorbent contactor structure may be enhanced by increasing the gas flow performance of the structure, and/or by increasing the volumetric density of the adsorbent layer material in the structure, when other structural variables are held constant. Such preferable increase in the gas flow performance of the structure may be indicated by a decrease in the value of the GFP for improved contactor structure embodiments. Therefore, in similar structures incorporating any chosen active material layer material, such as an adsorbent sheet material of a particular composition and dimensions, an increase in relative adsorptive performance may be realized by reducing the spacer layer thickness (thus increasing the volumetric density of the adsorbent layer material, by reducing volumetric density of spacer layer material in the contactor structure) and/or by increasing the gas flow performance of the structure (characterized by reducing the pressure drop across the structure). By varying the spacer layer material and spacer thickness used in exemplary contactor structures, and comparing the values of the GFP obtained for each contactor structure embodiment, preferred structure embodiments may be identified as those having relatively lower values of the GFP, and more preferably also having less thick spacer material layers.

As shown in FIG. 1, multiple parallel passage contactor structures comprising multiple adsorbent and spacer layers configured in a spirally wound contactor structure inside a cylindrical enclosure were prepared and tested using air as a test fluid to determine the value of the GFP for each structure. The parallel passage contactor structures tested included structures incorporating materials known in the art, and improved structures as disclosed herein, incorporating an improved spacer layer material. When comparing the values of the GFP obtained for the structures incorporating materials known in the art, it can be seen that gas flow performances of such conventional structures were limited to GFP values greater than about 1.8E-4 Pa*s/m. In contrast, improved contactor structures as disclosed herein displayed improved gas flow performance corresponding to GFP values less than about 1.8E-4 Pa*s/m. Such improved gas flow performance corresponding to GFP values less than about 1.8E-4 Pa*s/m were not achievable with the contactor structures according to the prior art. Further, the improved contactor structures displayed the desired improved gas flow performance corresponding to GFP values less than about 1.8E-4 Pa*s/m for smaller values of spacer thickness than those of the conventional structures tested, which have less desirable gas flow performance (GFP values greater than about 1.8E-4 Pa*s/m).

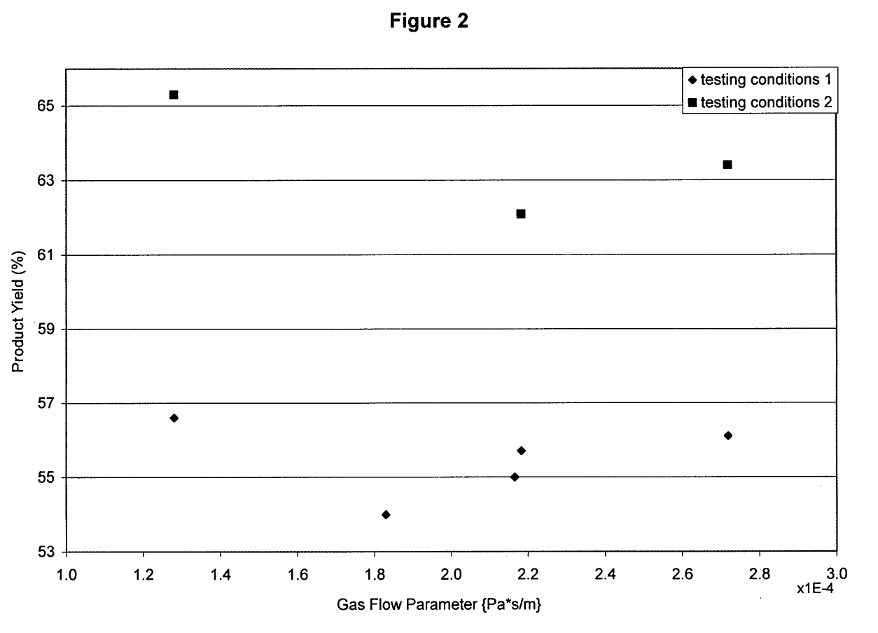

The relationship between the increased gas flow performance of the improved contactor structures as measured by the value of the GFP (GFP values of less than about 1.8E-4 Pa*s/m for the improved inventive structures) and the performance of the improved contactor structures for adsorptive gas separation is shown in FIG. 2. FIG. 2 illustrates the product gas yield obtained as a percent of product gas in the feed for a RCPSA separation process for enriching a desired product gas from a feed gas mixture containing the product gas in combination with undesired diluent gas components, as a function of the GFP value of the contactor structure used in the RCPSA process. In FIG. 2, product gas yields are shown for conventional (according to the prior art, corresponding to GFP values of greater than about 1.8E-4 Pa*s/m) and improved (corresponding to GFP values of less than about 1.8E-4 Pa*s/m) contactor structures comprising identical adsorbent layer materials each tested under 2 different test conditions corresponding to two different RCPSA process cycles producing enriched product gas at different representative purities. As can be seen from FIG. 2, for both testing conditions, improved contactor structures according to the present invention having improved gas flow performance reflected by a value of the GFP less than about 1.8E-4 Pa*s/m give substantially improved adsorptive yield performance relative to conventional contactor structures with lesser gas flow performance reflected by GFP values greater than about 1.8E-4 Pa*s/m.

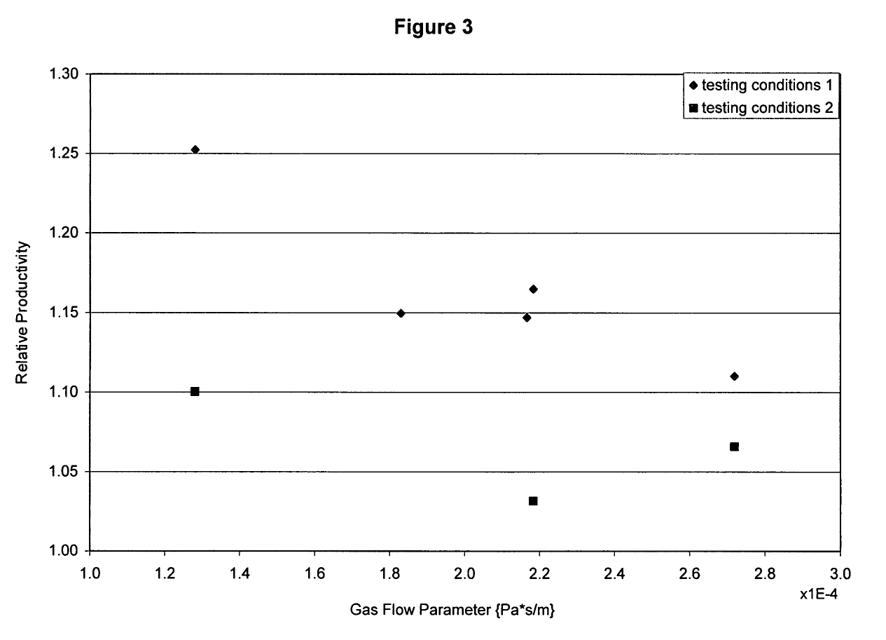

The relationship between the increased gas flow performance of the improved contactor structures according to the present invention as measured by the value of the GFP (GFP values of less than about 1.8E-4 Pa*s/m for the improved inventive structures) and the performance of the improved contactor structures for adsorptive gas separation is further illustrated in FIG. 3. FIG. 3 illustrates the relative normalized productivity of the adsorbent contactor structure (productivity measured as liters of product gas produced per liter of adsorbent structure volume per hour, normalized for relative comparison) for a RCPSA separation process for enriching a desired product gas from a feed gas mixture containing the product gas in combination with undesired diluent gas components, as a function of the GFP value of the contactor structure used in the RCPSA process. In FIG. 3, normalized relative contactor productivity values are shown for conventional (according to the prior art corresponding to GFP values of greater than about 1.8E-4 Pa*s/m) and improved (according to the present invention with GFP values of less than about 1.8E-4 Pa*s/m) contactor structures comprising identical adsorbent layer materials tested under the same two test conditions as were used for the product yield measurements in the data shown in FIG. 2 and described accordingly above. As can be seen from FIG. 3, for both testing conditions, improved contactor structures according to the present invention having improved gas flow performance reflected by a value of the GFP less than about 1.8E-4 Pa*s/m give substantially improved normalized adsorptive productivity performance relative to conventional contactor structures with lesser gas flow performance reflected by GFP values greater than about 1.8E-4 Pa*s/m.

Through the production and performance testing of the improved parallel passage contactor structures, some suitable improved spacer layer materials have been identified for use in combination with the above described sheet-type adsorbent (or other active materials such as catalysts or absorbents) layer materials, to provide the improved contactor structures.

In a preferred embodiment, mesh-type spacer layer materials having greater than about 85% open volume ratio may be used in combination with adsorbent sheet layers to construct an improved contactor structure according to the present invention which may be applied to adsorptive gas separation, such as PSA, RCPSA, temperature or partial pressure swing adsorption. Such improved mesh-type spacer materials may be constructed out of materials selected from the list comprising plastic, metal, ceramics, glass including glass fibers, crystalline microporous materials, polymeric material, carbon, and combinations thereof, provided the open volume ratio of the material is at least about 85%. In applications requiring high contactor temperatures such as gas catalytic reaction, mesh spacer materials may comprise high temperature tolerant materials such as certain ceramics, or alloys such as FeCrAlY. The value of the open volume ratio for the spacer material is defined by the equation described in the Summary above, and may be calculated using basic measurements of the mesh spacer material including the thickness of the spacer material, and the thickness and spacing of the filaments making up the mesh. Pressure drop testing (using air as a test fluid) of improved contactor structures comprising the above improved mesh spacer materials in combination with sheet-type adsorbent layer materials has been found to result in GFP values less than about 1.8E-4 Pa*s/m for such improved contactor structures incorporating the improved mesh spacer materials with open volume ratio values of greater than about 85%.

In some particular embodiments of improved contactor structures, metal mesh materials constructed of stainless steel may be incorporated in the structure as exemplary improved mesh spacer materials having open volume ratio values greater than about 85%. Such exemplary improved mesh spacer materials may include stainless steel meshes comprising 304 or 316 alloy stainless steel filaments with filament diameters ranging between about 50-160 microns, such as 51, 64, 76, 140, or 152 microns, spaced in a grid-like mesh with inter-filament spacing ranging between about 600-2600 microns, such as 605, 706, 847, 1155, 1270, 1814 or 2540 microns.

In other embodiments of the improved parallel passage contactor structure, other suitable non-mesh type spacer materials may be utilized in combination with active material sheet layers to produce improved contactor structures having GFP values less than about 1.8E-4 Pa*s/m in pressure drop tests using air as a test fluid. Such other suitable non-mesh type spacer materials may comprise fabrics, perforated sheets or foils, expanded foils or other thin or sheet-like structures constructed of materials comprising plastic, metal, ceramic, glass, crystalline microporous material, polymeric material, or carbon (may be activated carbon). In applications requiring high contactor temperatures such as gas catalytic reaction, spacer materials may comprise high temperature tolerant materials such as certain ceramics, or alloys such as FeCrAlY. Further suitable non-mesh spacer materials may also comprise printed, extruded, sprayed, embossed, or otherwise formed spheres, columns, teardrops, or other three-dimensional shapes sufficient to space adjacent active material sheet layers from each other to provide gas flow channels in the improved contactor structure. Such further suitable spacer materials may be comprised of ceramic, polymeric, glass, metal, silicone, cellulosic, crystalline microporous, adsorbent, or other shape-stable materials, or combinations thereof.

The improved parallel passage contactor structures may also provide further improvements relative to conventional structures, in addition to increased gas flow performance for many potential applications such as adsorptive gas separation, catalytic gas reaction and others. Improved contactor structures incorporating the improved mesh-type spacer materials described above which have open volume ratio (OVR) values greater than about 85% may be lighter in weight than comparable mesh spacer materials of similar construction with OVR values below 85%, relative to existing structures, and therefore also result in lighter weight RCPSA (or other application specific) modules or machines incorporating the improved contactor structures. Such lighter weight of the inventive contactor structures and eventual equipment incorporating the inventive structures may be particularly advantageous in applications requiring compact and light apparatus, such as RCPSA or catalytic reaction for mobile or transportation uses. Such mobile uses may include compact RCPSA hydrogen purification for fuel cell use in automotive applications, for example. Further, the improved mesh spacer materials used in some embodiments of the inventive contactor structure may be less expensive for a given quantity of material than similar spacer materials having OVR values below about 85%. Due to the inclusion of a large number of spacer material layers in many gas processing contactor structures and equipment, the lower cost for such improved mesh spacer materials in the structures may reduce the cost of the inventive contactor structures relative to existing structures, which may be particularly advantageous in applications requiring low cost gas processing equipment, such as compact RCPSA or partial pressure swing adsorption.

The present invention has been described above in reference to several exemplary embodiments. It is understood that further modifications may be made by a person skilled in the art without departing from the spirit and scope of the invention which are to be determined by the following claims.

What is claimed is:

1. A parallel passage contactor structure comprising:
at least one active material sheet layer; and
at least one spacer material layer positioned adjacent to the at least one active material sheet layer to establish a gas flow channel adjacent to and in contact with the active material sheet layer, wherein a Gas Flow Parameter (GFP) value for the parallel passage contactor structure resulting from pressure drop testing using air as a test fluid is less than about 1.8E-4 Pa*s/m, wherein the Gas Flow Parameter (GFP) is defined by the following equation:
$$GFP \{ Pa * s / m \} = \frac{\begin{matrix}[ Pressure drop of contactor structure ] * \\ {[ spacer layer thickness ]}^{3}\end{matrix}}{\begin{matrix}[ length ] * [ x \text{-} sectional area of contactor structure ] * \\ [ gas entrance velocity ]\end{matrix}}$$

2. The parallel passage contactor structure according to claim 1 wherein at least a portion of the active material sheet layer comprises at least one adsorbent material.

3. The parallel passage contactor structure according to claim 2 wherein the at least one adsorbent material is selected from the list comprising molecular sieves, zeolites, activated carbons, carbon molecular sieves, silica gels, aluminas and combinations thereof.

4. The parallel passage contactor structure according to claim 1 wherein at least a portion of the active material sheet layer comprises at least one catalytic material.

5. The parallel passage contactor structure according to claim 3 wherein the active material sheet layer has a thickness, and wherein the spacer material layer has a thickness between about 25% and 200% of the active material sheet layer thickness, such that the parallel passage contactor is configured for use as a parallel passage adsorbent element for use in a pressure swing, partial pressure swing, or temperature swing adsorption module.

6. The parallel passage contactor structure according to claim 1 wherein the spacer material layer comprises stainless steel wire mesh comprised of stainless steel wire filaments, and wherein the stainless steel wire filaments have a diameter between about 50 and 160 microns and are spaced with an inter-filament spacing distance between about 600 and 2600 microns.

7. The parallel passage contactor structure according to claim 5 wherein the spacer material layer comprises mesh, fabric, perforated sheets or foils, expanded foils or other thin or sheet-like structures constructed of materials selected from the list comprising plastic, metal, ceramic, glass, crystalline microporous material, polymeric material, carbon, or combinations thereof.

8. A parallel passage contactor structure comprising:
at least one active material sheet layer; and
at least one mesh spacer material layer positioned adjacent to the at least one active material sheet layer to establish a gas flow channel adjacent to and in contact with the active material sheet layer, and wherein an Open Volume Ratio (OVR) value of the at least one mesh spacer material layer is greater than about 85%, wherein the Open Volume Ratio (OVR) is defined by the following equation:
OVR=(total volume of mesh spacer layer)−(volume of mesh material filaments)/(total volume of mesh spacer layer)×100%

9. The parallel passage contactor structure according to claim 8 wherein at least a portion of the active material sheet layer comprises at least one adsorbent material.

10. The parallel passage contactor structure according to claim 9, wherein the at least one adsorbent material is selected from the list comprising molecular sieves, zeolites, activated carbons, carbon molecular sieves, silica gels, aluminas and combinations thereof.

11. The parallel passage contactor structure according to claim 8 wherein at least a portion of the active material sheet layer comprises at least one catalytic material.

12. The parallel passage contactor structure according to claim 10 wherein the active material sheet layer has a thickness, and wherein the mesh spacer material layer has a thickness between about 25% and 200% of the active material sheet layer thickness, such that the parallel passage contactor is configured for use as a parallel passage adsorbent element for use in a pressure swing, partial pressures swing, or temperature swing adsorption module.

13. The parallel passage contactor structure according to claim 8 wherein the mesh spacer material layer comprises stainless steel wire mesh comprised of stainless steel wire filaments, and wherein the stainless steel wire filaments have a diameter between about 50 and 160 microns and are spaced with an inter-filament spacing distance between about 600 and 2600 microns.

14. The parallel passage contactor structure according to claim 8 wherein the mesh spacer material layer comprises a mesh constructed from material selected from the list comprising:
plastic, metal, ceramic, glass including glass fibers, crystalline microporous materials, polymer, carbon or combinations thereof.

15. A parallel passage contactor structure comprising:
at least one active material sheet layer; and
at least one spacer material layer positioned adjacent to the at least one active material sheet layer to establish a fluid flow channel adjacent to and in contact with the active material sheet layer, wherein a Gas Flow Parameter (GFP) value for the parallel passage contactor structure resulting from pressure drop testing using air as a test fluid is less than about 1.8E-4 Pa*s/m, wherein the Gas Flow Parameter (GFP) is defined by the following equation:
$$GFP \{ Pa * s / m \} = \frac{\begin{matrix}[ Pressure drop of contactor structure ] * \\ {[ spacer layer thickness ]}^{3}\end{matrix}}{\begin{matrix}[ length ] * [ x \text{-} sectional area of contactor structure ] * \\ [ gas entrance velocity ]\end{matrix}} .$$
